(19) United States
(12) Patent Application Publication
(10) Pub. No.: US 2026/0250457 A1
(43) Pub. Date: Aug. 27, 2026

(54) CONDUCTIVE RESIN COMPOSITION

(71) Applicant: THREEBOND CO., LTD., Hachioji-shi, Tokyo (JP)

(72) Inventors: Satoru ENDO, Hachioji-shi, Tokyo (JP); Takashi NEMOTO, Hachioji-shi, Tokyo (JP); Takashi SUZUKI, Hachioji-shi, Tokyo (JP)

(21) Appl. No.: 18/879,231

(22) PCT Filed: Jun. 29, 2023
(86) PCT No.: PCT/JP2023/024208

§ 371 Date: Dec. 26, 2024

(30) Foreign Application Priority Data
Jun. 30, 2022 (JP) 2022-105366

(51) Int. Cl. C08G 59/24; C08G 59/28; C08G 59/50; C08K 3/08; C08K 7/00; C08K 9/04

(52) U.S. Cl. CPC C08G 59/245; C08G 59/28; C08G 59/5006; C08K 3/08; C08K 7/00; C08K 2003/0806; C08K 9/04; C08K 2201/001; C08K 2201/005; C08K 2201/006

(57) ABSTRACT

A conductive resin composition suppresses outgassing according to the present disclosure. A conductive resin composition contains the following components (A) to (D): component (A): a bisphenol type epoxy resin; component (B): an epoxy resin having a boiling point of 300° C. or more (excluding component (A)); component (C): conductive particles; and component (D): an epoxy resin curing agent.

### TECHNICAL FIELD

The present invention relates to a conductive resin composition that suppresses outgassing.

### BACKGROUND ART

Conventionally, conductive resin compositions have been used for fixing electric and electronic components such as smartphones and electronic mobile devices, and for earthing purposes. In recent years, conductive resin compositions used in electronic components are known to contain reactive diluents and solvents from the viewpoint of workability and the like (JP 2020-139020 A/corresponding to WO 2020-175056 A).

### SUMMARY OF INVENTION

However, when a conductive resin composition contains highly volatile compounds, these components may evaporate as outgassing (volatile gas) during heating and curing, and may adhere to other nearby components, causing malfunctions in electronic components.

As a result of extensive investigation for achieving the above object, the inventors have found a method for a conductive resin composition that suppresses outgassing, and completed the present invention.

The summary of the present invention is described below. One aspect of the present invention for solving the above problem relates to the following conductive resin composition.

[1] A conductive resin composition including the following components (A) to (D):
component (A): a bisphenol type epoxy resin;
component (B): an epoxy resin (excluding component (A)) with a boiling point of 300° C. or more;
component (C): conductive particles; and
component (D): an epoxy resin curing agent.

[2] The conductive resin composition according to [1], wherein a content of an epoxy resin having a boiling point of less than 300° C. and a solvent is 1.00% by mass or less with respect to the total mass of the composition.

[3] The conductive resin composition according to [1] or [2], wherein the component (B) is an epoxy resin containing two or more epoxy groups and having a boiling point of 300° C. or more.

[4] The conductive resin composition according to any one of [1] to [3], wherein the component (B) is a glycidylamine epoxy resin.

[5] The conductive resin composition according to any one of [1] to [4], wherein the mass ratio between the component (A) and the component (B) (component (A): component (B)) is 99:1 to 60:40.

[6] The conductive resin composition according to any one of [1] to [5], wherein the component (C) contains plate-shaped conductive particles as a component (c-1) and conductive particles other than the component (c-1) as a component (c-2).

[7] The conductive resin composition according to [6], wherein the components (c-1) and (c-2) are silver particles.

[8] The conductive resin composition according to [6] or [7], wherein the mass ratio between the component (c-1) and the component (c-2) (component (c-1): component (c-2)) is 20:80 to 70:30.

[9] The conductive resin composition according to any one of [1] to [8], wherein the component (D) is a latent epoxy resin curing agent.

[10] The conductive resin composition according to any one of [1] to [9], wherein the component (D) is a modified aliphatic polyamine-based latent epoxy resin curing agent.

[11] The conductive resin composition according to any one of [1] to [10], wherein the mass loss when the uncured conductive resin composition is heated from 25° C. to 80° C. at a heating rate of 10° C./min and then heated at 80° C. for 1 hour is less than 0.2% by mass.

[12] A cured product formed by curing the conductive resin composition according to any one of [1] to [11].

[13] A conductive resin composition including the following components (B) to (D):
component (B): a glycidylamine epoxy resin having a boiling point of 300° C. or more;
component (C): conductive particles; and
component (D): an epoxy resin curing agent.

### DESCRIPTION OF EMBODIMENTS

The details of the present invention are described below. The present invention is not limited to the following embodiments, and can be modified in various ways within the scope of the claims. In addition, the embodiments described in the present description can be combined in any way to form other embodiments.

Throughout the present description, the singular expression should be understood to include the concept of the plural, unless otherwise specified. Thus, the singular article (for example, in the case of English, “a”, “an”, and “the”) should be understood to include the concept of the plural, unless otherwise specified. In addition, the terms used in the present description should be understood to be used in the sense commonly used in the relevant field, unless otherwise specified. Thus, unless otherwise defined, all technical and scientific terms used in the present description have the same meaning as commonly understood by a person skilled in the art to which the present invention belongs. In the case of conflict, the present description (including definitions) will take precedence.

In the present description, “X to Y” means “X or more and Y or less”, with the numerical values written before and after (X and Y), being included as the lower and upper limits. In the present description, the term “(meth)acrylic” means both acrylic and methacrylic. In addition, unless otherwise specified, concentrations and % refer to mass concentrations and % by mass respectively, and ratios refer to mass ratios, unless otherwise specified. In addition, unless otherwise specified, operations and measurements of physical properties are performed under room temperature (20 to 25° C.) and relative humidity of 40 to 55% RH. In addition, “A and/or B” means each of A and B, and a combination thereof.

### [Conductive Resin Composition]

The conductive resin composition according to one aspect of the present invention (hereinafter also simply referred to as the “conductive resin composition according to the present invention” or the “conductive resin composition”) includes the following components (A) to (D):
component (A): a bisphenol type epoxy resin;
component (B): an epoxy resin having a boiling point of 300° C. or more (excluding component (A));
component (C): conductive particles; and
component (D): an epoxy resin curing agent.

That is, the conductive resin composition according to the present invention contains the above-described components (A) to (D). Having such a composition causes the conductive resin composition according to the present invention to generate little outgassing. This makes it suitable as a conductive resin composition used for bonding electronic components. In addition, the conductive resin composition according to the present invention has excellent conductivity and adhesive strength of the cured product. The details of this mechanism are unknown, but it is considered that the combination of resins contained as components (A) and (B) according to the present invention suppresses the generation of outgassing, and the component (C) can improve the conductivity and adhesive strength of the cured product in a favorably balanced manner.

### [Component (A)]

The component (A) used in the present invention is a bisphenol type epoxy resin. The component (A) being a bisphenol type epoxy resin provides excellent conductivity. The component (A) is not limited in structure, but is preferably a bisphenol type epoxy resin having a boiling point of 300° C. or more, thereby a boiling point of 300° C. or more eliminates the risk of contamination of electronic components due to outgassing. The boiling point of the bisphenol type epoxy resin of the component (A) is preferably 300° C. or more, more preferably 350° C. or more, still more preferably 400° C. or more, particularly preferably 420° C. or more, and most preferably 450° C. or more. The component (A) may be solid or liquid, and is not particularly limited, but preferably contains a compound having two or more epoxy groups (bisphenol multifunctional epoxy resin) from the viewpoint of excellent curability, and is preferably liquid at 25° C. from the viewpoint of excellent workability. That is, in one embodiment, the component (A) preferably has two or more epoxy groups, and is more preferably a bisphenol type epoxy resin that is liquid at 25° C.

For bisphenol multifunctional epoxy resins, the upper limit of the number of epoxy groups contained in one molecule is not particularly limited, but the number is preferably 6 or less. As an example, the number of epoxy groups contained in the compound as the component (A) is preferably 2 to 6 (di- to hexa-functional epoxy resin), more preferably 2 to 3 (di- to tri-functional epoxy resin), and particularly preferably 2 (difunctional epoxy resin). The epoxy group may be contained in the compound (epoxy resin) in the form of a glycidyl group.

Herein, in the present description, “liquid” means a state (liquid state) having fluidity at 25° C. Specifically, “liquid state at 25° C.” means a state of having the viscosity measured at 25° C. with a cone-plate rotational viscometer at a shear rate of 10 s⁻¹ is 1000 Pa·s or less. In the present description, the viscosity of the components is the viscosity measured at a shear rate of 10 s⁻¹ with a cone-plate rotational viscometer. As an example, the viscosity of the multifunctional epoxy resin used as the component (A) at 25° C. is preferably 0.01 Pa·s or more and less than 1000 Pa·s, more preferably 0.1 to 500 Pa·s, still more preferably 0.3 to 100 Pa·s, particularly preferably 0.5 to 10 Pa·s, and most preferably 0.8 to 5 Pa·s.

Specific examples of the component (A) include bisphenol A type epoxy resin, bisphenol F type epoxy resin, bisphenol S type, bisphenol AD type epoxy resin, urethane modified bisphenol type epoxy resin, rubber modified bisphenol type epoxy resin, and polyoxyalkylene modified bisphenol type epoxy resin. These may be used singly or in combination of two or more types, but it is preferable to use bisphenol A type epoxy resin and bisphenol F type epoxy resin in combination from the viewpoint of the excellent conductivity and workability.

In a case where the bisphenol A type epoxy resin and bisphenol F type epoxy resin are used in combination in the component (A), the mass ratio (bisphenol A type epoxy resin: bisphenol F type epoxy resin) is preferably 90:10 to 10:90, more preferably 85:15 to 15:85, still more preferably 80:20 to 20:80, particularly preferably 75:5 to 25:75, and most preferably 70:30 to 30:70, from the viewpoint of excellent curability and workability.

The epoxy equivalent of the bisphenol type epoxy resin used as the component (A) is not particularly limited, but from the viewpoint of further improving the adhesive strength, the epoxy equivalent is preferably 50 g/eq or mere to 300 g/eq or less, more preferably 100 g/eq or more to 250 g/eq or less, and particularly preferably 130 g/eq or more to 200 g/eq or less. In the present description, the epoxy equivalent is a value measured in accordance with JIS K-7236:2001. In addition, if the epoxy equivalent cannot be determined by this method, the epoxy equivalent may be calculated by dividing the molecular weight of the target epoxy resin (compound) by the number of epoxy groups contained in one molecule of the epoxy resin (compound).

Commercially available products of the component (A) include, but are not limited to, jER828, 1001, 801N, and 807 (manufactured by Mitsubishi Chemical Corporation), Epicron 830, 835, 840, 840-S, 850, 850-S, 850-LC, EXA-830CRP, EXA-830LVP, EXA-850CRP, and EXA-835LV (manufactured by DIC Corporation), ADEKA RESIN EP4100, EP4901, and EP4000 (manufactured by ADEKA Corporation), and D.E.R. 331, 332, 354, and 542 (manufactured by The Dow Chemical Company). These may be used singly or in combination of two or more types.

### [Component (B)]

The component (B) used in the present invention is an epoxy resin having a boiling point of 300° C. or more, excluding the component (A). That is, the component (B) is an epoxy resin having a boiling point of 300° C. or more, other than the bisphenol type epoxy resin. The component (B) is not limited in structure as long as it has a boiling point of 300° C. or more, thereby a boiling point of 300° C. or more eliminates concerns about contamination of electronic components due to outgassing. The boiling point of the epoxy resin of the component (B) is preferably 320° C. or more, more preferably 350° C. or more, still more preferably 380° C. or more, particularly preferably 400° C. or more, and most preferably 410° C. or more. In addition, the component (B) is preferably a liquid at 25° C. from the viewpoint of excellent workability. As an example, the viscosity at 25° C. of the epoxy resin used as the component (B) is preferably 0.01 Pa·s or more and less than 1000 Pa·s, more preferably 0.1 to 500 Pa·s, still more preferably 0.3 to 100 Pa·s, particularly preferably 0.4 to 10 Pa·s, and most preferably 0.5 to 5 Pa·s.

From the viewpoint of excellent curability, the epoxy resin having a boiling point of 300° C. or more as the component (B) preferably includes a compound having two or more epoxy groups, more preferably includes a compound having three or more epoxy groups, and most preferably includes a compound having three epoxy groups. According to one embodiment, from the viewpoint of excellent curability, the epoxy group as the component (B) is preferably a group selected from a glycidylamino group or a glycidyloxy group. According to one embodiment, therefore, the component (B) is preferably an epoxy resin (excluding the component (A)) having a boiling point of 300° C. or more and having one or more (preferably two or more) groups selected from the group consisting of a glycidylamino group and a glycidyloxy group.

Specific examples of the component (B) include alkylene glycol type epoxy resins, novolak type epoxy resins such as phenol novolak type epoxy resins and cresol novolak type epoxy resins, biphenyl type epoxy resins, hydrogenated bisphenol A type epoxy resins, hydrogenated bisphenol F type epoxy resins, glycidylamine type epoxy resins, naphthalene type epoxy resins, urethane modified epoxy resins, silicone modified epoxy resins, rubber modified epoxy resins, and rubber modified epoxy resins. These may be used singly or in combination of two or more types, but glycidylamine type epoxy resins are preferable because of the excellent curability thereof.

Examples of glycidylamine type epoxy resins include N, N-diglycidyl-4-glycidyloxyaniline, 4,4′-methylenebis(N, N-diglycidylaniline), tetraglycidyldiaminodiphenylmethane, tetraglycidyl-m-xylylenediamine, and 4-(2, 3-epoxypropan-1-yloxy)-N, N-bis(2, 3-epoxypropan-1-yl)-2-methylaniline. These may be used singly or in combination of two or more types.

The epoxy equivalent of the epoxy resin having a boiling point of 300° C. or more used as the component (B) is not particularly limited, but from the viewpoint of further improving the adhesive strength, the epoxy equivalent is preferably 30 g/eq or more and 200 g/eq or less, more preferably 50 g/eq or more and 180 g/eq or less, and particularly preferably 60 g/eq or more and 150 g/eq or less. The epoxy equivalent is a value measured by the method described above.

Commercially available products of the component (B) are not particularly limited, but examples thereof include jER604, jER630, YX4000, YX8000, and YX8034 (manufactured by Mitsubishi Chemical Corporation), ADEKA RESIN EP-3950S and EP-3950L (manufactured by ADEKA Corporation), Sumiepoxy ELM-100, ELM-100H, ELM-434, ELM-434L, and ELM-434VL (manufactured by Sumitomo Chemical Co., Ltd.), YH-404 and YH-513 (manufactured by NIPPON STEEL Chemical & Material Co., Ltd.), and Denacol EX252 (manufactured by Nagase ChemteX Corporation).

The mass ratio between the component (A) and the component (B) (mass of the component (A): mass of the component (B)) is preferably 99:1 to 60:40, more preferably 98:2 to 65:35, still more preferably 95:5 to 70:30, and most preferably 95:5 to 75:25, in order to obtain a conductive resin composition with excellent conductivity.

### [Component (C)]

The component (C) used in the present invention is a conductive particle. The material of the particle for the component (C) is not limited as long as it exhibits conductivity, and for example, can be appropriately selected from metal particles composed of one or more types of metals selected from the group consisting of gold, silver, copper, nickel, palladium, platinum, tin, bismuth, and the like, alloy particles composed of a combination of a plurality of these metals, or particles with the surface coated with the above metal as a coating layer (particles with the surface coated with a metal in which the core is an inorganic filler or an organic polymer). These may be used singly or in combination of two or more types, but from the viewpoints such as conductivity and cost, silver particles and/or particles with the surface coated with a coating layer of silver are preferable.

The average particle size (D50) of the component (C) is preferably in the range of 0.1 to 30 μm, more preferably in the range of 0.5 to 10 μm, and most preferably in the range of 1.5 to 5 μm, from the viewpoint of excellent conductivity. The average particle size of the component (C) is the particle size at a cumulative volume ratio of 50% (D50) in the particle size distribution determined by a laser diffraction scattering method. As an example, the average particle size of the component (C) can be measured by a laser diffraction scattering type shape distribution measuring instrument.

The content of the component (C) is preferably 50 to 500 parts by mass, more preferably 100 to 450 parts by mass, still more preferably 150 to 400 parts by mass, particularly preferably 180 to 350 parts by mass, and most preferably 200 to 300 parts by mass, with respect to 100 parts by mass of the total of the components (A) and (B). The content of the component (C) is 50 parts by mass or more, thereby resulting in a conductive resin composition with excellent conductivity to be obtained, and the content is 500 parts by mass or less, thereby resulting in a conductive resin composition with excellent workability to be obtained.

The shape of the component (C) may be spherical, plate-shaped, flake-shaped (thin plate-shaped), amorphous, scale-shaped, needle-shaped, or dendritic, and may be crystalline or non-crystalline. The component (C) may be used in a plurality of shapes, either singly or in combination.

In one embodiment, the component (C) may be plate-shaped conductive particles (component (c-1)) having a plate-like shape or non-plate-shaped conductive particles (component (c-2)) having a non-plate-like shape. Thus, in one embodiment, the component (C) includes one or more types selected from the group consisting of the component (c-1): plate-shaped conductive particles, and component (c-2): conductive particles other than component (c-1) (conductive particles excluding component (c-1)). Herein, the component (c-1) and the component (c-2) may each be used singly or in combination of two or more types.

In one embodiment, the component (C) preferably contains plate-shaped conductive particles as the component (c-1) and conductive particles other than the component (c-1) (conductive particles other than the component (c-1)) as the component (c-2). Containing a combination of the above conductive particles results in a conductive resin composition with excellent conductivity to be obtained.

The plate-shaped conductive particles are plate-shaped particles having uniform thickness obtained by growing one metal crystal face, generally have a size (size of the flat face) on the order of micrometers and a thickness on the order of nanometers, and have a polygonal plate shape such as a triangular plate shape, a hexagonal plate shape, a truncated triangular plate shape, a square plate shape, a pentagonal plate shape, or a hexagonal plate shape. Preferably, the plate-shaped conductive particles are plate-shaped (plate-like) particles having a thin-plate shape, a substantially (approximately or completely) uniform thickness, and a smooth surface.

The plate-shaped conductive particles can be produced by a known production method. The production method of the plate-shaped conductive particles is not particularly limited. Examples of the production method of the plate-shaped conductive particles include the production method shown in JP 2014-196527 A (corresponding to the description of US 2016-0001362).

The shape and surface condition of the particles can be confirmed by common techniques such as scanning electron microscopy (SEM). When observing a particle with a scanning electron microscope (SEM), it can be determined that the particle is a plate-shaped particle when it is visually confirmed in the SEM image that the particle has a plate-shaped (plate-like) shape, the thickness, which is the distance between the top and bottom surfaces (two bottom surfaces) of the plate-shaped (plate-like) shape, is substantially (approximately or completely) uniform within one particle, and the bottom surface of the plate-shaped (plate-like) shape is substantially (approximately or completely) smooth. In plate-shaped particles, when an SEM image is visually observed, the top and bottom surfaces (two bottom surfaces) of the plate-shaped (plate-like) shape are substantially (approximately or completely) parallel. In the present description, the plate-shaped (plate-like) shape does not include a plate-shaped (curved plate-like) shape with a clearly curved bottom surface. Therefore, in the present description, plate-shaped conductive particles do not include curved plate-shaped conductive particles.

The variation in thickness of the plate-shaped conductive particles is not particularly limited. In one embodiment, the variation in thickness of the plate-shaped conductive particles is preferably within a range of ±10% of the thickness of the powder (plate-shaped conductive particles), and more preferably within a range of ±5% of the thickness of the powder (plate-shaped conductive particles). The variation in thickness of the plate-shaped conductive particles is determined by measuring the thickness at three points per plate-shaped silver particle (one particle) using scanning electron microscope (SEM) and calculating the average value.

The arithmetic average roughness Ra of the surface of the plate-shaped conductive particles is not particularly limited. In one embodiment, the arithmetic average roughness Ra of the surface of the plate-shaped conductive particles is preferably 10.0 nm or less, more preferably 8.0 nm or less, and still more preferably 3.5 nm or less (lower limit 0 nm). The arithmetic average roughness Ra of the surface of the plate-shaped conductive particles is preferably 1.0 nm or more. Preferable examples of the range of the arithmetic average roughness of the surface of the plate-shaped conductive particles include, but are not limited to, 1.0 nm or more and 10.0 nm or less, 1.0 nm or more and 8.0 nm or less, and 1.0 nm or more and 3.5 nm or less. In the present description, the arithmetic average roughness Ra of the surface of the plate-shaped conductive particles can be evaluated using an atomic force microscope (AFM). An example of a method for measuring the arithmetic average roughness Ra of the surface of (c-1) is the method described in paragraphs “0023” to “0025” of JP 2014-196527 A (corresponding US to the specification of 2016/0001362). More specifically, an example of a method for measuring the arithmetic average roughness Ra of the surface of the plate-shaped conductive particles is a method in which, using a scanning probe microscope SPM-9600 manufactured by SHIMADZU CORPORATION, for example, the arithmetic average roughness is measured at a measurement distance of 2 μm on the flattest surface of 10 randomly selected particles under the following measurement conditions (when it is difficult to measure over a distance of 2 μm on the flattest surface, the largest possible distance on the surface), the average of the 10 arithmetic average roughnesses is calculated, and the calculated value is taken as the arithmetic average roughness Ra of the surface of the plate-shaped conductive particles.

### <Measurement Conditions>

Mode: contact mode
Cantilever: OMCL-TR800PSA-1, manufactured by OLYMPUS CORPORATION
Resolution: 512×512 pixels
Height-direction resolution: 0.01 nm
Traverse direction resolution: 0.2 nm

The plate-shaped conductive particles are preferably particles obtained by growing one metal crystal surface. That is, the plate-shaped conductive particles are preferably single crystals. Single crystals refer to crystals in which the orientation of single atoms or molecules is the same and regularly arranged. Being a single crystal, a conductive resin composition having excellent conductivity, such as a connection resistance value and volume resistivity, of the cured product can be obtained. The plate-shaped conductive particles preferably include single crystal plate-shaped conductive particles, more preferably are single crystal plate-shaped conductive particles, and still more preferably are single crystal plate-shaped silver particles.

Whether or not a conductive particle is crystalline can be determined by analyzing the presence or absence of a crystal structure using X-ray diffraction (XRD) or electron diffraction. For example, a case where a clear diffraction spot is obtained in an electron diffraction pattern is determined to have a crystalline structure, and a case where a continuous ring-shaped diffraction pattern is obtained instead of a clear diffraction spot is determined to have an amorphous structure.

The plate-shaped conductive particles, which are component (c-1), are not limited in terms of the material of the particles as long as they exhibit conductivity, and for example, can be appropriately selected from metal particles made of one or more types of metals selected from gold, silver, copper, nickel, palladium, platinum, tin, bismuth, and the like, alloy particles made by combining a plurality of these metals, or particles with the surfaces coated with the above-described metals as a coating layer (particles with the surfaces coated with metals in which the cores are inorganic fillers or organic polymers). These may be used singly or in combination of two or more types, but from the viewpoints such as conductivity, cost, and the like, silver particles and/or particles with the surfaces coated with silver as a coating layer are preferable.

The component (c-1) may be surface-treated with a lubricant. The plate-shaped conductive particles preferably include plate-shaped conductive particles that have been surface-treated with a lubricant, more preferably are plate-shaped conductive particles that have been surface-treated with a lubricant, and still more preferably are plate-shaped silver particles. As the lubricant, a saturated fatty acid and/or an unsaturated fatty acid can be used. Examples of the lubricant include capric acid, undecylic acid, lauric acid, tridecylic acid, myristic acid, pentadecylic acid, palmitic acid, margaric acid, stearic acid, linolenic acid, linoleic acid, palmitoleic acid, and oleic acid, but stearic acid is preferable in terms of excellent dispersibility and storage stability. These may be used singly or in combination of two or more. The lubricant preferably contains at least one type selected from the group consisting of the compounds listed above, and more preferably is at least one type selected from the group consisting of the compounds listed above. As an example, the lubricant preferably includes stearic acid, and more preferably is stearic acid.

The plate-shaped conductive particles, which are component (c-1), are produced by a known production method, such as the production method shown in JP 2014-196527 A.

Further, the component (c-1) is preferably a single crystal. A single crystal is a crystal in which single atoms or molecules are arranged regularly and in the same direction. Being a single crystal, a conductive resin composition having excellent conductivity can be obtained.

The average particle size of the plate-shaped conductive particles, which are the component (c-1), is preferably 0.1 μm or more and less than 1,000 μm from the viewpoint of excellent conductivity. In addition, the average particle size of the plate-shaped conductive particles is preferably in the range of 0.1 to 30 μm, more preferably in the range of 0.1 to 20 μm, still more preferably in the range of 0.2 to 18 μm, particularly preferably in the range of 0.2 to 15 μm, and most preferably in the range of 0.3 to 15 μm. In one embodiment, the average particle size of the component (c-1) may be 0.2 to 10 μm, 0.2 to 8 μm, 0.3 to 10 μm, 0.3 to 5 μm, 0.4 to 15 μm, 0.4 to 10 μm, or 0.4 to 5 μm. Herein, the average particle size of the component (c-1) is the particle size (D50) at a cumulative volume ratio of 50% in the particle size distribution determined by a laser diffraction scattering method. As an example, the average particle size of the component (c-1) can be measured by a laser diffraction scattering shape distribution measuring instrument. In addition, the reason is unclear, but it is preferable to use two or more types of different particle sizes in combination, from the viewpoint of excellent adhesive strength. When using two or more types of different particle sizes in combination, the mass ratio between the component (c-1) having the larger particle size and the component (c-1) having the smaller particle size (mass ratio of component (c-1) having larger particle size: component (c-1) having smaller particle size) is preferably 90:10 to 30:70, more preferably 80:20 to 40:60, and most preferably 70:30 to 50:50.

The thickness (average thickness T) of the plate-shaped conductive particles, which are the component (c-1), is not particularly limited, but from the viewpoint of excellent conductivity, the thickness is preferably 1 nm or more and less than 1000 nm, more preferably 10 to 200 nm, still more preferably 30 to 150 nm, particularly preferably 40 to 120 nm, and most preferably 50 to 100 nm. In one embodiment, the thickness (average thickness T) of the component (c-1) may be 1 to 200 nm, 5 to 150 nm, 10 to 100 nm, 20 to 180 nm, 30 to 150 nm, 40 to 130 nm, 45 to 120 nm, 50 to 110 nm, or 60 to 100 nm. The thickness (average thickness T) of the component (c-1) can be confirmed using a scanning electron microscope (SEM). More specifically, the thickness can be obtained by randomly selecting 100 plate-shaped conductive particles, measuring the thickness of each, and calculating the average value. The thickness of each of the plate-shaped conductive particles is measured based on the SEM image.

The aspect ratio of the plate-shaped conductive particles, which are the component (c-1), is not particularly limited, but from the viewpoint of excellent conductivity, the aspect ratio is preferably 1.5 or more, more preferably from 1.5 to 100, still more preferably from 5 to 100, particularly preferably from 10 to 75, and most preferably from 10 to 60. The aspect ratio of the component (c-1) may be from 5 to 80, or from 8 to 60. In addition, the reason is unclear, but it is preferable to use two or more types with different aspect ratios in combination from the viewpoint of excellent adhesive strength. If two or more types with different aspect ratios are used in combination, the aspect ratio of the particle with the larger aspect ratio is preferably in the above-described aspect ratio range. If two or more types of particles with different aspect ratios are used in combination, the aspect ratio of the particles with a smaller aspect ratio is preferably 1.2 or more, more preferably from 1.2 to 50, still more preferably from 1.3 to 40, particularly preferably from 1.4 to 30, and most preferably from 1.5 to 20. The mass ratio between the component (c-1) of the particles with a larger aspect ratio and the component (c-1) of the particles with a smaller aspect ratio (mass ratio of the component (c-1) of the particles with a larger aspect ratio: the component (c-1) of the particles with a smaller aspect ratio) is preferably 90:10 to 30:70, more preferably 80:20 to 40:60, and most preferably 70:30 to 50:50. The aspect ratio of the component (c-1) can be calculated by dividing the average particle size measured by a laser diffraction scattering shape distribution measuring instrument by the thickness (average thickness T) measured by a scanning electron microscope (SEM), using the formula (average particle size)/(average thickness T).

The specific surface area of the plate-shaped conductive particles, which are the component (c-1), is preferably in the range of 0.1 to 7.0 m²/g, more preferably 0.3 to 5.0 m²/g, still more preferably 0.5 to 3.0 m²/g, particularly preferably 0.50 to 3.00 m²/g, and most preferably 1.00 to 3.00 m²/g. If the specific surface area of the plate-shaped conductive particles is 0.1 m²/g or more, a conductive resin composition with excellent conductivity can be obtained, and if 7.0 m²/g or less, a conductive resin composition with excellent workability can be obtained. In another embodiment, the specific surface area of the plate-shaped conductive particles is preferably 0.50 m²/g or more, more preferably 0.50 to 7.00 m²/g, still more preferably 0.50 to 5.00 m²/g, particularly preferably 0.50 to 3.00 m²/g, and most preferably 0.90 to 3.00 m²/g. Herein, the specific surface area is a value calculated by the BET method.

The plate-shaped conductive particles of the component (c-1) may be synthetic products and/or commercially available products. There is no particular limitation on the commercially available plate-shaped conductive particles. Commercially available products of the component (c-1) are not particularly limited, but examples thereof include N300, M612, M13, M27, and LM1 (manufactured by Tokusen Kogyo Co., Ltd.).

As the plate-shaped conductive particles of the component (c-1), one type of plate-shaped conductive particles may be used, or two or more types of plate-shaped conductive particles may be used in combination.

The content of the plate-shaped conductive particles, which are the component (c-1), is preferably 20 to 300 parts by mass, more preferably 30 to 200 parts by mass, still more preferably 35 to 190 parts by mass, particularly preferably 40 to 180 parts by mass, and most preferably 50 to 150 parts by mass, with respect to 100 parts by mass of the total of the components (A) and (B). According to one embodiment, the content of the component (c-1) may be 30 to 150 parts by mass, 50 to 130 parts by mass, 50 to 120 parts by mass, or 50 to 100 parts by mass, with respect to 100 parts by mass of the total of the components (A) and (B). When the content of component (c-1) is 20 parts by mass or more, a conductive resin composition having excellent electrical conductivity and adhesive strength can be obtained, and when the content of the component (c-1) is 300 parts by mass or less, a conductive resin composition having excellent workability can be obtained. If two or more types of bisphenol type epoxy resins are used as the component (A), the content of the component (A) is intended to be the total amount thereof. If two or more types of epoxy resins having a boiling point of 300° C. or more are used as the component (B), the content of the component (B) is intended to be the total amount thereof. In addition, if two or more types of plate-shaped conductive particles are used as the component (c-1), the content of the component (c-1) is intended to be the total amount thereof.

The component (c-2) is a conductive particle other than the component (c-1). That is, the component (c-2) is a conductive particle other than the plate-shaped conductive particle (hereinafter also simply referred to as “conductive particle of the component (c-2)”), and is a conductive particle not included in the component (c-1). The conductive particle of the (c-2) is not particularly limited in terms of the material or shape of the particle, as long as it exhibits conductivity. The conductive particles of component (c-2) in combination with component (c-1) further improve the conductivity.

The conductive particles of the component (c-2) can be appropriately selected from, for example, metal particles made of one type selected from the group consisting of gold, silver, copper, nickel, palladium, platinum, tin, bismuth, and the like; alloy particles made by combining a plurality of metals selected from the group consisting of these metals; and particles with the surface coated with the above-described metals as a coating layer (particles with the surface coated with metals in which core is the inorganic filler or organic polymer). These may be used singly, or two or more types may be used in combination. From the viewpoints such as conductivity and cost, (c-2) preferably contains metal particles, more preferably contains metal particles containing at least one type selected from the group consisting of gold, silver, copper, nickel, palladium, platinum, tin, and bismuth, and still more preferably contains silver particles. As an example, from the viewpoints such as conductivity and cost, the (c-2) is preferably a metal particle, more preferably a metal particle containing at least one type selected from the group consisting of gold, silver, copper, nickel, palladium, platinum, tin, and bismuth, and still more preferably a silver particle and/or a particle with the surface coated with a coating layer of silver.

The shape of the component (c-2) is not particularly limited. The shape of the component (c-2) may be spherical, amorphous, flake-shaped (scale-like), filament-shaped (needle-like), or dendritic, and is preferably non-crystalline and is preferably flake-shaped. These may be used singly or in combination. In the present description, flake-shaped particles refer to thin particles other than plate-shaped particles (thin particles excluding plate-shaped particles). The component (c-2) preferably contains flake-shaped particles, more preferably contains flake-shaped silver particles, and still more preferably is flake-shaped silver particles. However, if the component (c-2) contains silver particles, the silver particles are not plate-shaped silver particles. In addition, regardless of whether the component (c-2) is silver particles, the component (c-2) is preferably conductive particles having a shape other than plate-shaped particles.

As described above, the shape and surface condition of the particles can be confirmed by common techniques such as a scanning electron microscope (SEM). Whether or not the component (c-2) is a plate-shaped (plate-like) thin particle with a uniform thickness can be determined by observing the particles with a scanning electron microscope (SEM), similar to the determination of the shape of the component (c-1) described above. Whether or not the surface of the component (c-2) is smooth can be determined by observing the particles with SEM images, similar to the determination of the surface condition of the component (c-1) described above.

The thickness variation of the component (c-2) is not particularly limited. If the component (c-2) contains flake-shaped conductive particles, the thickness variation of the flake-shaped conductive particles is preferably more than ±10% of the thickness of the powder (the flake-shaped conductive particles). In another embodiment, the component (c-2) is a flake-shaped conductive particle, and the thickness variation of the flake-shaped conductive particles is preferably more than ±10% of the thickness of the powder (the flake-shaped conductive particles). In yet another embodiment, the thickness variation of the component (c-2) is more than ±10% of the thickness of the powder (conductive particles other than plate-shaped conductive particles). The thickness variation of the component (c-2) is determined by measuring the thickness at three points per powder (conductive particles other than plate-shaped conductive particles) (one particle) using scanning electron microscope (SEM) and calculating the average value.

In one embodiment, as preferable examples, the thickness variation of the component (c-1) is within a range of ±10% (preferably within a range of ±5%) with respect to the thickness of the powder (the plate-shaped conductive particles), and if the component (c-2) contains flake-shaped conductive particles, the thickness variation of the flake-shaped conductive particles is preferably more than +10% with respect to the thickness of the powder (the flake-shaped conductive particles).

In another embodiment, as preferable examples, the thickness variation of the component (c-1) is within a range of ±10% (preferably within a range of ±5%) with respect to the thickness of the powder (the plate-shaped conductive particles), and the component (c-2) is a flake-shaped conductive particle, and the thickness variation of the flake-shaped conductive particle is more than ±10% with respect to the thickness of the powder (the flake-shaped conductive particle).

In yet another embodiment, as preferable examples, the thickness variation of the component (c-1) is within a range of ±10% (preferably within a range of ±5%) with respect to the thickness of the powder (plate-shaped conductive particles), and the thickness variation of the component (c-2) is more than ±10% with respect to the thickness of the powder (conductive particles other than the plate-shaped conductive particles).

The arithmetic average roughness Ra of the surface of the component (c-2) is not particularly limited. In one embodiment, if the component (c-2) contains flake-shaped conductive particles, the arithmetic average roughness of the surface of the flake-shaped conductive particles is preferably more than 10.0 nm. If the component (c-2) contains flake-shaped conductive particles, the arithmetic average roughness of the surface of the flake-shaped conductive particles is preferably 20 μm or less. In another embodiment, the component (c-2) is more preferably a flake-shaped conductive particle having an arithmetic average roughness of the surface of more than 10.0 nm. The component (c-2) is preferably a flake-shaped conductive particle having an arithmetic average roughness of the surface of 20 μm or less. In yet another embodiment, the arithmetic average roughness of the surface of the component (c-2) is more preferably more than 10.0 nm. The arithmetic average roughness of the surface of the component (c-2) is preferably 20 μm or less. The arithmetic average roughness Ra of the surface of the component (c-2) can be evaluated in the same manner as the arithmetic average roughness of the surface of the component (c-1).

In one embodiment, as preferable examples, the arithmetic average roughness Ra of the surface of the component (c-1) is 10.0 nm or less (preferably, 8.0 nm or less, 3.5 nm or less, 1.0 nm or more and 10.0 nm or less, 1.0 nm or more and 8.0 nm or less, 1.0 nm or more and 3.5 nm or less, and the like), and if the component (c-2) contains flake-shaped conductive particles, the arithmetic average roughness Ra of the surface of the flake-shaped conductive particles is more than 10.0 nm (preferably, more than 10.0 nm and 20 μm or less, and the like).

In another embodiment, as preferable examples, the arithmetic average roughness Ra of the surface of the component (c-1) is 10.0 nm or less (preferably, 8.0 nm or less, 3.5 nm or less, 1.0 nm or more and 10.0 nm or less, 1.0 nm or more and 8.0 nm or less, 1.0 nm or more and 3.5 nm or less, and the like), and the arithmetic average roughness Ra of the surface of the component (c-2) is more than 10.0 nm (preferably, more than 10.0 nm and 20 μm or less, and the like).

In yet another embodiment, as preferable examples, the arithmetic average roughness Ra of the surface of the component (c-1) is 10.0 nm or less (preferably, 8.0 nm or less, 3.5 nm or less, 1.0 nm or more to 10.0 nm or less, 1.0 nm or more to 8.0 nm or less, 1.0 nm or more to 3.5 nm or less, and the like), and the arithmetic average roughness Ra of the surface of the component (c-2) is more than 10.0 nm (preferably, more than 10.0 nm to 20 μm or less, and the like).

The component (c-2) may be surface-treated with a lubricant. The (c-2) preferably contains conductive particles that have been surface-treated with a lubricant, and more preferably is conductive particles that have been surface-treated with a lubricant. The lubricant is not particularly limited. For example, a saturated fatty acid and/or an unsaturated fatty acid can be used as the lubricant. For example, the lubricant contains at least one type selected from the group consisting of saturated fatty acids and unsaturated fatty acids, and is preferably at least one type selected from the group consisting of saturated fatty acids and unsaturated fatty acids. Examples of the lubricant includes capric acid, undecylic acid, lauric acid, tridecylic acid, myristic acid, pentadecylic acid, palmitic acid, margaric acid, stearic acid, linolenic acid, linoleic acid, palmitoleic acid, and oleic acid, and stearic acid is preferable from the viewpoint of excellent dispersibility and storage stability. These may be used singly, or may be used in a combination of two or more types. The lubricant preferably contains at least one type selected from the group consisting of the compounds listed above, and more preferably contains stearic acid. As an example, the lubricant is preferably at least one type selected from the group consisting of the compounds listed above, and more preferably is stearic acid.

For example, in the conductive resin composition, as a preferable example, the components (c-1) and (c-2) are conductive particles (preferably silver particles) that have been surface-treated with stearic acid.

The component (c-2) is preferably non-crystalline. When the component (c-2) is non-crystalline, the electrical conductivity is further improved when the component (c-2) is combined with the component (c-1).

In one embodiment, the component (c-1) is a crystalline conductive particle, and the component (c-2) is a non-crystalline conductive particle. More preferably, the component (c-1) is a crystalline silver particle, and the component (c-2) is a non-crystalline silver particle.

The average particle size of the component (c-2) is preferably 0.1 to 30 μm, more preferably 0.5 to 20 μm, still more preferably 1 to 10 μm, and particularly preferably 1.0 μm or more and less than 4.0 μm, from the viewpoint of excellent conductivity. If the average particle size of the component (c-2) is 30 μm or less, a conductive resin composition having excellent conductivity of the cured product can be obtained. Herein, the average particle size of the component (c-2) is the particle size (D50) at a cumulative volume ratio of 50% in the particle size distribution determined by a laser diffraction scattering method.

For example, in the conductive resin composition, as a preferable example, the average particle size of each of the components (c-1) and (c-2) is 0.1 to 30 μm.

The specific surface area of the component (c-2) is not particularly limited. In one embodiment, the specific surface area of the component (c-2) is preferably 0.01 to 10 m²/g, more preferably 0.1 to 5.0 m²/g, still more preferably 0.2 to 3.0 m²/g, and particularly preferably 0.20 m²/g or more and less than 0.50 m²/g. If the specific surface area of the component (c-2) is 0.01 m²/g or more, a conductive resin composition having excellent conductivity of the cured product can be obtained. If the specific surface area of the component (c-2) is 10 m²/g or less, a conductive resin composition having excellent workability can be obtained. In another embodiment, the specific surface area of the component (c-2) is preferably 0.01 m²/g or more and less than 0.50 m²/g, more preferably 0.10 m²/g or more and less than 0.50 m²/g, and still more preferably 0.20 m²/g or more and less than 0.50 m²/g. The specific surface area herein is a value calculated by the BET method.

In one embodiment, as preferable examples, the specific surface area of the component (c-1) is 0.50 m²/g or more (for example, 0.50 m²/g or more, 0.50 to 7.00 m²/g, 0.50 to 5.00 m²/g, 0.50 to 3.00 m²/g, 0.90 to 3.00 m²/g, and 1.00 to 3.00 m²/g), and the specific surface area of the component (c-2) is 0.01 m²/g or more and less than 0.50 m²/g (for example, 0.10 m²/g or more and less than 0.50 m²/g, and 0.20 m²/g or more and less than 0.50 m²/g) when the component (c-2) is a flake-shaped silver particle, and is 0.01 to 10.00 m²/g (for example, 0.01 to 10.00 m²/g, 0.10 to 5.00 m²/g, and 0.20 to 3.00 m²/g) when the component (c-2) is a particle other than a flake-shaped silver particle.

In another embodiment, as preferable examples, the specific surface area of the component (c-1) is 0.50 m²/g or more (for example, 0.50 m²/g or more, 0.50 to 7.00 m²/g, 0.50 to 5.00 m²/g, 0.50 to 3.00 m²/g, 0.90 to 3.00 m²/g, and 1.00 to 3.00 m²/g), the component (c-2) is a flake-shaped silver particle, and the specific surface area of the component (c-2) is 0.01 m²/g or more and less than 0.50 m²/g (for example, 0.10 m²/g or more and less than 0.50 m²/g, and 0.20 m²/g or more and less than 0.50 m²/g).

In yet another embodiment, as preferable examples, the specific surface area of the component (c-1) is preferably 0.50 m²/g or more (for example, 0.50 m²/g or more, 0.50 to 7.00 m²/g, 0.50 to 5.00 m²/g, 0.50 to 3.00 m²/g, 0.90 to 3.00 m²/g, and 1.00 to 3.00 m²/g), and the specific surface area of the component (c-2) is preferably 0.01 m²/g or more and less than 0.50 m²/g (for example, 0.10 m²/g or more and less than 0.50 m²/g, and 0.20 m²/g or more and less than 0.50 m²/g).

As the component (c-2), a synthetic product and/or a commercially available product may be used. There is no particular limitation on the commercially available product of the component (c-2). Examples of the commercially available product of the component (c-2) include Sylbest (registered trademark) TC-770 (manufactured by Tokuriki Honten Co., Ltd.).

As the component (c-2), one type of conductive particles may be used, or two or more types of conductive particles may be used in combination.

The content of the component (c-2) is preferably 50 to 500 parts by mass, more preferably 80 to 400 parts by mass, still more preferably 100 to 300 parts by mass, and most preferably 150 to 250 parts by mass, with respect to 100 parts by mass of the total of the components (A) and (B). When the content of component (c-2) is 50 parts by mass or more, a conductive resin composition with excellent conductivity can be obtained, and when the content of component (c-2) is 500 parts by mass or less, a conductive resin composition with excellent workability can be obtained. If two or more types of conductive particles are used as the component (c-2), the content of the component (c-2) means the total amount thereof.

The mass ratio between the component (c-1) and the component (c-2) is preferably 10:90 to 90:10, more preferably 15:85 to 85:15, still more preferably 20:80 to 70:30, particularly preferably 22:78 to 60:40, and most preferably 25:75 to 50:50, from the viewpoint of capable of obtaining a conductive resin composition having excellent conductivity. When the mass ratio between the component (c-1) and the component (c-2) is within the above range, a conductive resin composition having excellent conductivity, such as the connection resistance value and volume resistivity of the cured product, can be obtained.

The total content of the components (c-1) and (c-2) is preferably 35 to 95% by mass, more preferably 40 to 90% by mass, still more preferably 45 to 85% by mass, particularly preferably 50 to 80% by mass, and most preferably 55 to 75% by mass, with respect to the total mass (100% by mass) of the conductive resin composition. When the total content of components (c-1) and (c-2) with respect to the total mass of the conductive resin composition is 35% by mass or more, a conductive resin composition having excellent conductivity can be obtained. When the total content of components (c-1) and (c-2) with respect to the total mass of the conductive resin composition is 95% by mass or less, a conductive resin composition having excellent workability can be obtained.

The total content of the components (c-1) and (c-2) is preferably 50 to 700 parts by mass, more preferably 80 to 600 parts by mass, even more preferably 100 to 500 parts by mass, particularly preferably 150 to 400 parts by mass, and most preferably 200 to 300 parts by mass, with respect to 100 parts by mass of the total of the components (A) and (B). When the total content of components (c-1) and (c-2) is 50 parts by mass or more with respect to 100 parts by mass of the total of the components A) and (B), a conductive resin composition with excellent conductivity can be obtained. When the total content of components (c-1) and (c-2) is 700 parts by mass or less with respect to 100 parts by mass of the total of components (A) and (B), a conductive resin composition with excellent workability can be obtained.

### [Component (D)]

A component (D) used in the present invention is an epoxy resin curing agent. The component (D) is not particularly limited as long as it cures epoxy resin, but a latent epoxy resin curing agent is preferable from the viewpoint of the balance between storage stability and curability. Examples of the latent epoxy resin curing agents include imidazole compounds, adduct-type latent epoxy resin curing agents (reaction products obtained by reacting amine compounds with epoxy compounds, isocyanate compounds, or urea compounds), dicyandiamide, hydrazide compounds, boron trifluoride-amine complexes, thiol compounds, and acid anhydrides, but the adduct-type latent epoxy resin curing agents are preferable from the viewpoint of the balance between storage stability and curability. These may be used singly or in combination of two or more. The component (D) preferably contains at least one type selected from the group consisting of the compounds listed above, and is more preferably at least one type selected from the group consisting of the compounds listed above.

The adduct-type latent epoxy resin curing agents are not particularly limited, and examples thereof include reaction products obtained by reacting amine compounds with isocyanate compounds or urea compounds (urea adduct-type latent epoxy resin curing agents) or reaction products obtained by reacting amine compounds with epoxy compounds (epoxyamine adduct-type latent epoxy resin curing agents), but from the viewpoint of the balance between storage stability and curability, urea adduct-type latent epoxy resin curing agents are preferable, and modified aliphatic polyamine-based latent epoxy resin curing agents are more preferable. The adduct-type latent curing agent may be used singly or two or more types may be used in combination. The urea-adduct-type latent curing agent and the epoxyamine-adduct-type latent curing agent may each be used singly or two or more types may be used in combination.

The component (D) may be either liquid or solid, but from the viewpoint of storage stability, the component (D) is preferably a solid at 25° C., and still more preferably a powder. In the present description, “solid” means a state that has substantially no fluidity at 25° C. Specifically, “state that has substantially no fluidity at 25° C.” refers to a state in which the viscosity measured at 25° C. using a cone-plate rotational viscometer at a shear rate of 10 s⁻¹ is more than 1,000 Pa·s, or the fluidity is extremely low or nonexistent and the viscosity cannot be measured at 25° C. using a cone-plate rotational viscometer at a shear rate of 10 s⁻¹.

If the component (D) is a powder, the average particle size of the powder is not particularly limited, but is preferably in the range of 0.1 to 30 μm, more preferably in the range of 0.5 to 20 μm, and most preferably 1 to 10 μm. If the average particle size of the powder is 0.1 μm or more, the viscosity of the conductive resin composition is less likely to increase. If the average particle size of the powder is 30 μm or less, the contact area between the component (E) and the component (A) increases, resulting in better curability. Herein, the average particle size of the component (D) is the particle size (D50) at a cumulative volume ratio of 50% in the particle size distribution determined by a laser diffraction scattering method.

As the component (D), a synthetic product and/or a commercially available product may be used. There is no particular limitation on the commercially available product of the component (D). For example, examples of urea-adduct-type latent epoxy resin curing agents include Fujicure FXE-1000, FXR-1020, FXR-1030, FXB-1050, and FXR-1081 (manufactured by T&K TOKA CO., LTD.). Examples of epoxy amine-adduct-type latent epoxy resin curing agents include Amicure PN-23, Amicure PN-H, Amicure PN-31, Amicure PN-40, Amicure PN-50, Amicure PN-F, Amicure PN-23J, Amicure PN-31J, Amicure PN-40J, Amicure MY-24, Amicure MY-25, Amicure MY-R, and Amicure PN-R (manufactured by Ajinomoto Fine-Techno Co., Inc.). These may be used singly, or two or more types may be used in combination.

The content of the component (D) is preferably 1 to 100 parts by mass, more preferably 5 to 80 parts by mass, still more preferably 10 to 50 parts by mass, particularly preferably 12 to 45 parts by mass, and most preferably 15 to 40 parts by mass, with respect to 100 parts by mass of the total of the components (A) and (B). When the content of component (D) is 1 part by mass or more with respect to 100 parts by mass of the total of the components (A) and (B), a conductive resin composition with excellent curability can be obtained, and when the content of component (D) is 100 parts by mass or less with respect to 100 parts by mass of the total of the components (A) and (B), a conductive resin composition with excellent storage stability can be obtained. If two or more types of epoxy curing agents are used as the component (D), the content of the component (D) means the total amount thereof.

[Epoxy Resin with a Boiling Point of Less than 300° C.]

For the conductive resin composition of the present invention, the content ratio of the epoxy resin having a boiling point of less than 300° C. is preferably 1.00% by mass or less, more preferable 0.10% by mass or less with respect to the entire conductive resin composition, and most preferably the epoxy resin having a boiling point of less than 300° C. is not contained. If the conductive resin composition contains more than 1% by mass of epoxy resin having a boiling point of less than 300° C., there is a concern that components that do not react during heat curing generate as outgassing and contaminate other portions of the electronic component. If 1.00% by mass or less, there is no concern of outgassing occurring during heat curing.

Examples of the epoxy resin having a boiling point of less than 300° C. include a reactive diluent, specifically, 1,4-butanediol diglycidyl ether, n-butyl ether, glycidyl allyl glycidyl ether, 2-ethylhexyl glycidyl ether, styrene oxide, phenyl glycidyl ether, cresyl glycidyl ether, p-sec-butylphenyl glycidyl ether, glycidyl methacrylate, t-butylphenyl glycidyl ether, diglycidyl ether, (poly)ethylene glycol glycidyl ether, butanediol glycidyl ether, trimethylolpropane triglycidyl ether, 1,6-hexanediol diglycidyl ether, 4-tert-butylphenyl glycidyl ether, and neodecanoic acid glycidyl ester.

### [Organic Solvent]

For the conductive resin composition of the present invention, the content ratio of the organic solvent is preferably 1.00% by mass or less with respect to the entire conductive resin composition. If the conductive resin composition contains more than 1.00% by mass of an organic solvent, the organic solvent may dissolve the component (D) and cause deterioration in storage stability, or outgassing may occur during heat curing, contaminating other portions of the electronic component. The amount of organic solvent is preferably 1.00% by mass or less, more preferably 0.10% by mass or less with respect to the entire conductive resin composition, and most preferably the organic solvent is not contained. If 1.00% by mass or less, there is no concern about deterioration in storage stability or outgassing during heat curing.

The organic solvent is liquid at 25° C. As described above, “liquid at 25° C.” means that the viscosity measured at 25° C. using a cone-plate rotational viscometer at a shear rate of 10 s⁻¹ is 1,000 Pa·s or less. If the conductive resin composition contains a solvent, the organic solvent dissolves the component (E), which deteriorates the storage stability or causes separation of the organic solvent, and thus the physical properties are affected. In the present description, “the conductive resin composition does not contain an organic solvent” means that the conductive resin composition does not intentionally contain an organic solvent as a formulation, and specifically means that the content of the organic solvent is 1% by mass or less with respect to the entire conductive resin composition (total mass of the conductive resin composition). Thus, in the conductive resin composition according to this embodiment, the content of the organic solvent is 0% by mass, or more than 0% by mass and 1% by mass or less, relative to the entire conductive resin composition (total mass of the conductive resin composition). The content of the organic solvent is preferably 0.5% by mass or less, more preferably 0.1% by mass or less, and still more preferably 0.01% by mass or less (lower limit: 0% by mass), with respect to the entire conductive resin composition (total mass of the conductive resin composition). It is particularly preferable that the conductive resin composition does not contain any organic solvent, that is, the content of the organic solvent is 0% by mass with respect to the entire conductive resin composition (total mass of the conductive resin composition). If the content of the organic solvent is 1% by mass or less with respect to the entire conductive resin composition (total mass of the conductive resin composition), deterioration of storage stability and separation do not occur.

Examples of the organic solvent include: aromatic-based organic solvents such toluene and xylene; aliphatic-based organic solvents such as n-hexane; alicyclic-based organic solvents such as cyclohexane, methylcyclohexane, and ethylcyclohexane; ketone-based organic solvents such as acetone and methyl ethyl ketone; alcohol-based organic solvents such as methanol and ethanol; ester-based organic solvents such as ethyl acetate and butyl acetate; and propylene glycol ether-based organic solvents such as propylene glycol methyl ether, propylene glycol ethyl ether, and propylene glycol t-butyl ether. If two or more organic solvents are used in combination, the content is the total amount thereof. As one example, the organic solvent may contain at least one type of the organic solvent selected from the group consisting of aromatic-based organic solvents, aliphatic-based organic solvents, alicyclic-based organic solvents, ketone-based organic solvents, alcohol-based organic solvents, ester-based organic solvents, and propylene glycol ether-based organic solvents, and may be at least one type of the organic solvent selected from the group consisting of aromatic-based organic solvents, aliphatic-based organic solvents, alicyclic-based organic solvents, ketone-based organic solvents, alcohol-based organic solvents, ester-based organic solvents, and propylene glycol ether-based organic solvents.

For the conductive resin composition of the present invention, the total content of the epoxy resin having a boiling point of less than 300° C. and the organic solvent is preferably 1.00% by mass or less, more preferably 0.10% by mass or less with respect to the entire conductive resin composition, and most preferably the epoxy resin having a boiling point of less than 300° C. and the organic solvent are not contained in the conductive resin composition.

### [Optional Components]

In addition to the above-described components, various additives can be added as optional components to the conductive resin composition of the present invention, as long as they do not impair the effects of the present invention. Examples of the additives include silane coupling agents, plasticizers, fillers (excluding the component (C)), storage stabilizers, tackifiers, metal complexes, organic or inorganic pigments, rust inhibitors, defoamers, dispersants, surfactants, viscoelasticity adjusters, and thickeners.

The conductive resin composition of the present invention may contain other fillers other excluding the component (C). Examples of the filler include glass, silica, talc, mica, ceramics, calcium carbonate, carbon powder, kaolin clay, dried clay minerals, dried diatomaceous earth, and rubber particles, and the rubber particles are preferable from the viewpoint of not deteriorating conductivity.

The rubber particles referred to in the present invention are particles containing a layer having rubber elasticity. The rubber particles may be particles made of only one layer having rubber elasticity, or may be core-shell particles, which are particles with a multi-layer structure having rubber elasticity, but core-shell particles are preferable from the viewpoint of excellent volume resistivity. In addition, rubber particles dispersed in an epoxy resin previously may be used. For example, butadiene rubber, acrylic rubber, silicone rubber, butyl rubber, olefin rubber, styrene rubber, NBR, SBR, IR, and EPR may be used. These may be used singly or in combination of two or more types.

Core-shell particles are fine particles in which portions of the core (nucleus) and shell (wall) of the particle are made of polymers with different properties. In the production of the preferable powder particles used in the present invention, the core portion is first produced by polymerizing a polymerizable monomer. Examples of the polymerizable monomer include: a (meth)acrylate monomer such as n-propyl (meth)acrylate, n-butyl (meth)acrylate, 2-ethylhexyl (meth)acrylate, and n-decyl (meth)acrylate; aromatic vinyl compounds such as styrene, vinyl toluene, and α-methylstyrene; vinyl cyanide compounds such as acrylonitrile and methacrylonitrile; vinylidene cyanide, 2-hydroxyethyl (meth)acrylate, 3-hydroxybutyl (meth)acrylate, 2-hydroxyethyl fumarate, hydroxybutyl vinyl ether, monobutyl maleate, and butoxyethyl methacrylate, and further, a crosslinkable monomer having two or more reactive groups such as ethylene glycol di(meth)acrylate, butylene glycol di(meth)acrylate, di(meth)acrylate, trimethylolpropane trimethylolpropane tri(meth)acrylate, hexanediol di(meth)acrylate, hexanediol tri(meth)acrylate, oligoethylene di(meth)acrylate, and oligoethylene tri(meth)acrylate; an aromatic divinyl monomer such as divinylbenzene; triallyl trimellitate, and triallyl isocyanerate, and these can be used singly or in combination of two or more different types. Then, a second polymerization is performed using the polymer particles thus obtained as a core, and polymerizing polymerizable monomers to form a shell made of a polymer having a melting point of a room temperature or more. The polymerizable monomer used in this case can be selected from the same polymerizable monomers used to obtain the core. Preferable examples of the polymerizable monomer used as a shell material include a (meth)acrylate with an alkyl group containing 1 to 4 carbon atoms, such as ethyl (meth)acrylate, n-butyl acrylate, methyl methacrylate, and butyl methacrylate.

The core-shell particles may be synthesized as described above, or commercially available ones may be used. Commercially available core-shell particles are not particularly limited, but there can be used Paraloid EXL-2655 (Kureha Chemical Industry Co., Ltd.), which is made of butadiene, alkyl methacrylate, and styrene copolymer; Stafiloid AC-3355, Stafiloid AC3364, Stafiloid TR-2105, Stafiloid TR-2102, Stafiloid TR-2122, Stafiloid IM-101, Stafiloid IM-203, Stafiloid IM-301, Stafiloid IM-401, and Stafiloid IM-406, which are made of acrylic acid ester and methacrylic acid ester IM-601 acrylic copolymer; Stafiloid made of acid ester-acrylonitrile-styrene copolymer; Zefiac F-351G (manufactured by Aica Kogyo Co., Ltd.) made of polymethacrylic acid ester polymer; and Paraloid EXL-2314, EXL-2611, and EXL-3387 (manufactured by Dow Chemical Japan Co., Ltd.). These may be used singly or in combination of two or more types.

The particle size of the rubber particles is preferably 0.01 to 10 μm, and more preferably 0.05 to 5 μm. The particle size is 0.01 μm or more, thereby an increase in viscosity is suppressed, and the particle size is 10 μm or less, thereby a conductive resin composition having excellent conductivity can be obtained.

The content of the rubber particles is preferably 0.01 to 20 parts by mass, more preferably 0.03 to 10 parts by mass, and most preferably 0.05 to 5 parts by mass, with respect to 100 parts by mass of the total of the components (A) and (B). When the content is within the above range, a conductive resin composition having excellent electrical conductivity such as connection resistance value and volume resistivity can be obtained.

Specific examples of rubber particles dispersed previously in epoxy resin include rubber particles dispersed in epoxy resin using a mixing and stirring device such as a hyper or homogenizer, and rubber particles synthesized in epoxy resin by emulsion polymerization. These may be used singly or in combination of two or more types. The epoxy resin with the rubber particles dispersed is treated as the above-described component (A) or component (B).

Examples of commercially available rubber-dispersed epoxy resins include Kane Ace MX-153, MX-136, MX-257, MX-127, and MX-451 (manufactured by Kaneka Corporation), Acryset BPF-307, and BPA-328 (manufactured by Nippon Shokubai Co., Ltd.). These may be used singly or in combination of two or more types.

The conductive resin composition of the present invention may contain a storage stabilizer. The storage stabilizer is not particularly limited as long as it improves storage stability, but borate ester compounds, phosphoric acid, alkyl phosphate esters, p-toluenesulfonic acid, methyl p-toluenesulfonate, and the like may be blended. Examples of the borate ester compound include trimethyl borate, triethyl borate, tri-n-propyl borate, triisopropyl borate, tributyl borate, trihexyl borate, tri-n-octyl borate, tris(2-ethylhexyloxy) borane, triphenylborate, trimethoxyboroxine, and 1, 3, 2-dioxaborolane-4, 5-dione. Examples of the commercially available borate ester compound include “Cureduct L-07N” (manufactured by SHIKOKU CHEMICALS CORPORATION). Examples of alkyl phosphate esters that can be used include, but are not limited to, trimethyl phosphate and tributyl phosphate. The storage stabilizer may be used singly or in combination. In consideration of storage stability, the storage stabilizer is preferably phosphoric acid, tributyl borate, trimethoxyboroxine, methyl p-toluenesulfonate or 1, 3, 2-dioxaborolane-4, 5-dione.

The conductive resin composition of the present invention may contain a metal complex. The reason is not clear, but the addition of a metal complex improves the conductivity of the adherend outermost surface of which is nickel. Examples of the metal contained in the metal complex include zinc, aluminum, iron, cobalt, nickel, tin, and copper and examples of the organic ligand include acetate, acetylacetate, hexanoate, and phthalocyanate, although they are not limited thereto.

Examples of the metal complex include, but are not limited to, copper oleate (divalent), zinc acetylacetate (divalent), aluminum acetylacetate (divalent), cobalt acetylacetate (divalent), nickel acetate, nickel acetylacetate (divalent), iron phthalocyanine (divalent), and dibutyltin dilaurate.

Specific examples of metal complexes include, but are not limited to, the acetylacetone metal complex series manufactured by Nippon Chemical Industry Co., Ltd., such as Nursem Zn, Nursem AL, Nursem Co, and Nursem Ni, and the octylic acid metal soap series manufactured by Kyodo Chemical Company Limited, such as KS-1260.

The conductive resin composition of the present invention preferably contains 0.01 to 20 parts by mass of the metal complex, and more preferably 0.5 to 15 parts by mass, with respect to 100 parts by mass of the total of components (A) and (B). The metal complex is contained in an amount of 0.01 part by mass or more, thereby the connection resistance is reduced, and the metal complex is contained in an amount of 20 parts by mass or less, thereby storage stability can be maintained.

The conductive resin composition according to one embodiment is substantially made of the above-described components (A) to (D) and at least one type selected from the group consisting of a storage stabilizer, a silane coupling agent, a filler (preferably rubber particles), and a metal complex. The conductive resin composition according to a preferable embodiment is substantially made of the above-described components (A) to (D) and a storage stabilizer. In the above embodiment, “the conductive resin composition is substantially composed of X” means that the total content of X is more than 99% by mass (upper limit: 100% by mass) in a case where the total mass of the conductive resin composition is 100% by mass (relative to the entire conductive resin composition). For example, “the conductive resin composition according to the present invention is substantially made of the above-described components (A) to (D) and at least one type selected from the group consisting of a storage stabilizer, a silane coupling agent, a filler (preferably rubber particles), and a metal complex” means that the total content (total amount added) of the above-described components (A) to (D), the storage stabilizer, the silane coupling agent, the filler (preferably rubber particles), and the metal complex exceeds 99% by mass (upper limit: 100% by mass) when the total mass of the conductive resin composition is 100% by mass (with respect to the entire conductive resin composition). For example, “the conductive resin composition according to the present invention is substantially composed of the above components (A) to (D) and a storage stabilizer” means that the total content (total amount added) of the components (A) to (D) and a storage stabilizer is more than 99% by mass (upper limit: 100% by mass) in a case where the total mass of the conductive resin composition is 100% by mass (with respect to the entire conductive resin composition).

The conductive resin composition according to the present embodiment causes little outgassing. For example, in the outgassing test in the examples described later, the amount of mass loss when the conductive resin composition is heated is less than 0.2% by mass. Specifically, the conductive resin composition according to the above aspect has a mass loss of preferably less than 0.2% by mass, more preferably less than 0.20% by mass, still more preferably 0.15% by mass or less, and particularly preferably less than 0.15% by mass, when the uncured conductive resin composition is heated from 25° C. to 80° C. at a heating rate of 10° C./min and then heated at 80° C. for 1 hour. In addition, in the conductive resin composition according to the above aspect, when an uncured conductive resin composition is heated from 25° C. to 80° C. at a heating rate of 10° C./min and then heated at 80° C. for 2 hours, the mass loss is preferably less than 0.2% by mass, more preferably less than 0.20% by mass, still more preferably 0.15% by mass or less, and particularly preferably less than 0.15% by mass.

### <Cured Product>

The conductive resin composition according to the above aspect can be cured by heating, and can be cured even at low temperatures (less than 100° C.). Therefore, another aspect of the present invention relates to a cured product (cured product of the conductive resin composition) obtained by curing the conductive resin composition according to the above aspect.

The conductive resin composition of the present invention can be cured at a low temperature (less than 100° C.). The heat curing temperature among the heating conditions of the curing method of the conductive resin composition of the present invention is not particularly limited, but is preferably 45 to 100° C., more preferably 50 to 95° C., from the viewpoint of less damage of the member by the adherend. The heat curing time is not particularly limited, but in the case of a heat curing temperature of 45 to 100° C., is preferably 10 minutes to 3 hours, more preferably 30 minutes to 2 hours, from the viewpoint of production efficiency of the production method using the conductive resin composition of the present invention. The cured product formed by curing the conductive resin composition of the present invention is also a part of the embodiment of the present invention.

The method for producing the cured product (the method for curing the conductive resin composition) is not particularly limited, and a known method can be used. One example is a method in which the conductive resin composition according to the above aspect is applied to an adherend, and then heated to be cured. Therefore, in order to improve the workability during application, it is preferable that the conductive resin composition is liquid (liquid-like). As one example, the viscosity of the conductive resin composition at 25° C. is preferably 0.01 Pa·s or more and less than 100 Pa·s, more preferably 0.1 to 50 Pa·s, still more preferably 0.5 to 50 Pa·s, particularly preferably 1 to 20 Pa·s, and still more particularly preferably 1 to 10 Pa·s.

When applying the conductive resin composition, the thickness of the applied film is not particularly limited, and is adjusted as appropriate within the range in which the adherend can be bonded. The heating conditions (curing conditions) are not particularly limited as long as the conductive resin composition can be sufficiently cured. Among the heating conditions in the method of curing the conductive resin composition, the heat curing temperature is not particularly limited, but from the viewpoint of reducing the thermal effect on the adherend, for example, a temperature of 45 to 100° C. is preferable, and a temperature of 50 to 95° C. is more preferable. The heat curing time is not particularly limited, but in the case of a heat curing temperature of 45 to 100° C., from the viewpoint of reducing the thermal effect on the adherend, 10 minutes to 3 hours is preferable, and 30 minutes to 2 hours is more preferable.

### <Adherend>

The conductive resin composition of the present invention can be used for electronic components that require conductivity, but because of excellent conductivity and adhesive strength, it can be used for adherends outermost surface of which is nickel, which has poor conductivity. That is, the conductive resin composition according to one aspect of the present invention and the cured product according to another aspect of the present invention are preferably used for adherends outermost surface of which is nickel. The adherend with an outermost surface containing nickel is not particularly limited, and is mainly nickel-plated, for example, SPCC (cold-rolled steel sheet), stainless steel, or copper member that has been electrolytically or electrolessly plated (electric wire, printed circuit board, and the like). The conductive resin composition having the above structure has a low connection resistance value of the cured product, excellent storage stability, and excellent handling properties, even when the adherend has a nickel outermost surface, although the exact reason is not clear.

### OTHER EMBODIMENTS

The conductive resin composition of the present invention can be used suitably even in cases where moderate conductivity is required. In this case, according to another embodiment of the present invention, a conductive resin composition including the following components (B) to (D) can be provided:
component (B): a glycidylamine type epoxy resin having a boiling point of 300° C. or more;
component (C): conductive particles; and
component (D): an epoxy resin curing agent.

The conductive resin composition according to the present embodiment has a conductivity of 10Ω or less, measured according to the method of the examples described later. The conductive resin composition according to the present embodiment has excellent conductivity and adhesive strength while reducing outgassing.

### EXAMPLE

The present invention will be described in more detail below with reference to examples, but the present invention is not limited to these examples. Further, unless otherwise specified, the tests were performed in an environment of 25° C. and 55% RH.

### Examples 1 to 10, Comparative Examples 1 to 3, Reference Examples 1 to 3

The following components were prepared to prepare a conductive resin composition. Hereinafter, the conductive resin composition is referred to simply as the composition.

### Component (A): A Bisphenol Type Epoxy Resin

Epicron EXA-835LV (boiling point 470° C. or more (mixture of bisphenol A type epoxy resin (boiling point: 487° C.) and bisphenol F type epoxy resin (boiling point: 474° C.), mixed mass ratio 50:50) epoxy equivalent: 165 g/eq, viscosity (25° C.): 2000 mPa·s (2 Pa·s), manufactured by DIC Corporation)

### Component (B): An Epoxy Resin Having a Boiling Point of 300° C. Or More (Excluding Component (A))

ADEKA RESIN EP-3950S (N,N-diglycidyl-4-glycidyloxyaniline, trifunctional glycidylamine type epoxy resin, boiling point: 420° C., epoxy equivalent: 95 g/eq, viscosity (25° C.): 650 mPa·s (0.65 Pa·s), manufactured by ADEKA Corporation)
   Component (B′): An Epoxy Resin Having a Boiling Point of Less than 300° C.
CARDURA E10P (Neodecanoic acid glycidyl ester, reactive diluent, boiling point: 278° C., manufactured by MOMENTIVE)
ADEKA GLYCILOR ED-509S (4-tert-butylphenyl glycidyl ether, reactive diluent, boiling point: 294° C., manufactured by ADEKA Corporation)

### Component (C): Conductive Particles

(c-1): Plate-Shaped Conductive Particles
M27 (single crystal silver particles, plate-shaped, stearic acid surface treatment, average particle size (D50): 4.5 μm, average thickness (T): 80 nm, aspect ratio (D50/T): 56, specific surface area: 1.0 m²/g, manufactured by Tokusen Kogyo Co., Ltd.)
LM1 (single crystal silver particles, plate-shaped, stearic acid surface treatment, average particle size (D50): 1.0 μm, average thickness (T): 60 nm, aspect ratio (D50/T): 1.6, specific surface area: 1.0 m²/g, manufactured by Tokusen Kogyo Co., Ltd.)
N300 (single crystal silver particles, plate-shaped, stearic acid surface treatment, average particle size (D50): 0.4 μm, average thickness (T): 50 nm, aspect ratio (D50/T): 8, specific surface area: 2.4 m²/g, manufactured by Tokusen Kogyo Co., Ltd.)
   (c-2): Conductive Particles Other than (c-1)
Sylvest TC-770 (flake-shaped silver particles (silver particles: non-crystalline), stearic acid surface treatment, average particle size (D50): 3.5 μm, specific surface area: 0.45 m²/g, manufactured by Tokuriki Honten Co., Ltd.)

### Component (D): An Epoxy Resin Curing Agent

Fujicure FXR-1081 (modified aliphatic polyamine-based latent curing agent (urea adduct-type latent curing agent) average particle size (D50): 5 μm, manufactured by T&K Toka Co., Ltd.) Optional component
Cureduct L-07N (storage stabilizer of epoxy-phenol-boric acid ester compound (including bifunctional bisphenol A type epoxy resin: 91% by mass, phenol novolak resin: 4% by mass, 2,2′-(carbonylbisoxy)bis(1, 3, 2-dioxaborolane-4, 5-dione: 5% by mass), manufactured by Shikoku Kasei Corporation).

The above Silbest (registered trademark) TC-770 (manufactured by TOKURIKI HONTEN CO., LTD.) used as (c-2) has a flaky shape. However, the thickness of Silbest (registered trademark) TC-770 (manufactured by TOKURIKI HONTEN CO., LTD.) varies greatly within a single particle, the upper and lower surfaces of the flakey shape are clearly not parallel, and significant unevenness and/or significant steps are observed on the particle surface. Therefore, Silbest (registered trademark) TC-770 (manufactured by TOKURIKI HONTEN CO., LTD.) is not a plate-shaped silver particle, but a flake-shaped silver particle.

The methods for producing the compositions according to Examples 1 to 12 and Comparative Examples 1 to 3 were as follows. The component (A), component (B) (or component (B′)), component (C), and any optional components were weighed and mixed for 30 minutes using a planetary mixer. The component (D) was then weighed and added, and stirring was performed for an additional 30 minutes using the planetary mixer while degassing under vacuum to provide a conductive resin composition. The obtained conductive resin compositions were all liquid at 25° C. The detailed preparation amounts are shown in Tables 1 and 2, and all values are represented in parts by mass.

### <Outgassing Test>

20 mg of each composition was weighed out, and each composition in an uncured state was heated from 25° C. to 80° C. at a heating rate of 10° C./min using a TG/DTA220 heat loss measuring device manufactured by Seiko Instruments Inc., and then measurements were taken continuously for 2 hours at 80° C., and the mass loss after 1 hour and 2 hours was measured. The mass loss in this measurement is regarded as the amount of outgassing. The mass loss is preferably less than 0.2% by mass, and more preferably less than 0.20% by mass, because of not contaminating electronic components.

### <Conductivity Measurement>

A masking tape 10 mm width and 100 μm thickness was drilled with 5 holes, 5 mm in diameter, at 10 mm intervals along the length. The masking tape was attached to an electroless nickel-plated plate 25 mm width×100 mm length×1.6 mm thickness, and the composition was coated with a squeegee. When coating with the squeegee, care was taken not to mix bubbles into the composition. The masking tape was then peeled off, and the composition was cured by heating at 80° C. for 1 hour in a hot air drying oven. After the temperature of the test pieces had dropped to room temperature, the needle electrodes of a dual display multimeter were touched to the cured products of adjacent compositions to measure the resistance. The resistance value (volume resistivity) of the resin itself and the resistance (connection resistance value) generated between the conductive resin composition and the electroless nickel-plated plate were measured, and the sum of these values was taken as “conductivity (Ω).” The conductivity is practically acceptable if 5.00Ω or less, preferably 1.00Ω or less, more preferably 0.50Ω or less, and most preferably 0.30Ω or less (lower limit: 0Ω).

### <Chip Adhesive Strength Measurement>

A masking tape was applied to an electroless nickel-plated plate of 1.6 mm thickness×25 mm width×100 mm length so as to have 5 mm width×50 μm thickness, and the composition was coated with a squeegee to form a uniform coating film, after which the masking tape was peeled off. A ceramic chip of 2φ×1 mm was dropped vertically onto the coating film from 1 cm above the coating film to make a test piece (n=5). The test piece was heated to 80° C. for 1 hour in a hot air drying oven to cure the composition. After the temperature of the test piece was lowered to room temperature, a digital force gauge with contacts was moved at 50 mm/min with the nickel-plated plate fixed, and the contacts were used to press the chip perpendicular to the long side of the test piece to measure the “maximum strength (N)”. The “chip adhesive strength (MPa)” was calculated from the adhesive area. In order to prevent the adherend from falling off, 10 MPa or more is preferable, 15 MPa or more is preferable, and 20 MPa or more is most preferable. In addition, in the table, “-” indicates that the measurement was not performed.

TABLE 1

| | Raw material | Ex. 1 | Ex. 2 | Ex. 3 | Ex. 4 | Ex. 5 | Ex. 6 | Ex. 7 | Ex.8 |
|---|---|---|---|---|---|---|---|---|---|
| Component (A) | Epicron EXA-835LV | 95 | 90 | 85 | 80 | 70 | 90 | 90 | 90 |
| Component (B) | ADEKA RESIN | 5 | 10 | 15 | 20 | 30 | 10 | 10 | 10 |
| | EP-3950S | | | | | | | | |
| Component (B′) | CARDURA E10P | | | | | | | | |
| | ADEKA | | | | | | | | |
| | GLYCILOR | | | | | | | | |
| | ED-509S | | | | | | | | |
| Component | M27 | 60 | 60 | 60 | 60 | 60 | 100 | 60 | 60 |
| (C):(c-1) | LM1 | | | | | | | 40 | |
| | N300 | | | | | | | | 40 |
| Component | Sylvest TC-770 | 180 | 180 | 180 | 180 | 180 | 180 | 180 | 180 |
| (C):(c-2) | | | | | | | | | |
| Component (D) | Fujicure FXR-1081 | 23 | 23 | 23 | 23 | 23 | 23 | 23 | 23 |
| Optional | Cureduct L-07N | 2.3 | 2.3 | 2.3 | 2.3 | 2.3 | 2.3 | 2.3 | 2.3 |
| component | | | | | | | | | |
| Total | | 365.3 | 365.3 | 365.3 | 365.3 | 365.3 | 405.3 | 405.3 | 405.3 |
| Content ratio of component (C) | | 66 | 66 | 66 | 66 | 66 | 69 | 69 | 69 |
| with respect to conductive | | | | | | | | | |
| resin composition (% by mass) | | | | | | | | | |
| Outgassing test | 80° C. for | 0.13 | 0.12 | 0.10 | 0.10 | 0.11 | 0.12 | 0.12 | 0.13 |
| Mass loss | 1 hour | | | | | | | | |
| (% by mass) | 80° C. for | 0.14 | 0.12 | 0.12 | 0.10 | 0.11 | 0.13 | 0.13 | 0.13 |
| | 2 hour | | | | | | | | |
| Conductivity | 80° C. for | 0.22 | 0.13 | 0.30 | 0.50 | 0.67 | 0.07 | 0.07 | 0.10 |
| (Ω) | 1 hour | | | | | | | | |
| Chip | 80° C. for | 22 | 22 | 22 | 20 | 19 | 23 | 25 | 20 |
| adhesive (MPa) | 1 hour | | | | | | | | |

TABLE 2

| | | | | | | Comp. | Comp. | Comp. | Ref. |
|---|---|---|---|---|---|---|---|---|---|
| | Raw material | Ex. 9 | Ex. 10 | Ex. 11 | Ex. 12 | Ex. 1 | Ex. 2 | Ex. 3 | Ex. 1 |
| Component (A) | Epicron EXA-835LV | 90 | 90 | 50 | 30 | 100 | 80 | 80 | |
| Component (B) | ADEKA RESIN | 10 | 10 | 50 | 70 | | | | 100 |
| | EP-3950S | | | | | | | | |
| Component (B′) | CARDURA E10P | | | | | | 20 | | |
| | ADEKA | | | | | | | 20 | |
| | GLYCILOR | | | | | | | | |
| | ED-509S | | | | | | | | |
| Component | M27 | | 280 | 60 | 60 | 60 | 60 | 60 | 60 |
| (C):(c-1) | LM1 | | | | | | | | |
| | N300 | | | | | | | | |
| Component | Sylvest TC-770 | 280 | | 180 | 180 | 180 | 180 | 180 | 180 |
| (C):(c-2) | | | | | | | | | |
| Component (D) | Fujicure FXR-1081 | 23 | 23 | 23 | 23 | 23 | 23 | 23 | 23 |
| Optional | Cureduct L-07N | 2.3 | 2.3 | 2.3 | 2.3 | 2.3 | 2.3 | 2.3 | 2.3 |
| component | | | | | | | | | |
| Total | | 405.3 | 405.3 | 365.3 | 365.3 | 365.3 | 365.3 | 365.3 | 365.3 |
| Content ratio of component (C) | | 69 | 69 | 66 | 66 | 66 | 66 | 66 | 66 |
| with respect to conductive | | | | | | | | | |
| resin composition (% by mass) | | | | | | | | | |
| Outgassing test | 80° C. for | 0.14 | 0.10 | 0.11 | 0.09 | 0.21 | 0.26 | 0.53 | 0.09 |
| Mass loss | 1 hour | | | | | | | | |
| (% by mass) | 80° C. for | 0.14 | 0.12 | 0.11 | 0.12 | 0.21 | 0.27 | 0.56 | 0.10 |
| | 2 hour | | | | | | | | |
| Conductivity | 80° C. for | 0.72 | 0.28 | 33 | 2.6 | 0.26 | 0.11 | 0.10 | 8.1 |
| (Ω) | 1 hour | | | | | | | | |
| Chip | 80° C. for | 12 | 27 | 27 | 22 | 20 | 28 | — | 27 |
| adhesive (MPa) | 1 hour | | | | | | | | |

Examples 1 to 5, 11, and 12 are compositions containing the components (A) to (D) and having different mass ratios between the component (A) and the component (B), and it was confirmed that conductivity and adhesive strength were excellent, and that mass loss was maintained low in the outgassing test. In addition, Example 6 is a composition with a high content of the component (C), and it is found to have excellent conductivity. Further, Examples 7 and 8 are compositions in which (c-1) is combined with plate-shaped conductive particles of different particle sizes, and it was confirmed that all of them had excellent conductivity and adhesive strength, and that mass loss was maintained low in the outgassing test. Examples 9 and 10 are compositions containing either (c-1) or (c-2) singly, but it was confirmed that all of them had excellent conductivity and adhesive strength, and that mass loss was maintained low in the outgassing test.

On the other hand, Comparative Example 1 is a composition that does not contain the component (B), and it was confirmed that the outgassing test showed a large mass loss and a large amount of outgassing. In addition, Comparative Examples 2 and 3 are compositions that contain an epoxy resin with a low boiling point as the component (B′) instead of component (B), and although the conductivity is excellent, it was confirmed that the outgassing test showed a large mass loss and a large amount of outgassing.

In addition, Reference Example 1 is a composition that does not contain the component (A), and it was confirmed that the mass loss was maintained significantly low in the outgassing test.

### INDUSTRIAL APPLICABILITY

The conductive resin composition of the present invention has excellent conductivity and suppresses outgassing, and thus is useful for conductive and adhesive applications for electrical and electronic components, and can reduce resistance to metals such as nickel that tend to have poor conductivity. In addition, by suppressing gas emission, it can also be used ideally for electronic components around lenses where contamination is a concern.

The present application is based on Japanese Patent Application No. 2022-105366, filed on Jun. 30, 2022, the disclosure of which is incorporated by reference in its entirety.

1. A conductive resin composition comprising the following components (A) to (D):
component (A): a bisphenol type epoxy resin;
component (B): an epoxy resin having a boiling point of 300° C. or more (excluding component (A));
component (C): conductive particles; and
component (D): an epoxy resin curing agent.

2. The conductive resin composition according to claim 1, wherein a content of an epoxy resin having a boiling point of less than 300° C. and a solvent is 1.00% by mass or less with respect to the total mass of the composition.

3. The conductive resin composition according to claim 1, wherein the component (B) is an epoxy resin containing two or more epoxy groups and having a boiling point of 300° C. or more.

4. The conductive resin composition according to claim 1, wherein the component (B) is a glycidylamine type epoxy resin.

5. The conductive resin composition according to claim 1, wherein a mass ratio between the component (A) and the component (B) (component (A): component (B)) is 99:1 to 60:40.

6. The conductive resin composition according to claim 1, wherein the component (C) comprises plate-shaped conductive particles as a component (c-1) and conductive particles other than the component (c-1) as a component (c-2).

7. The conductive resin composition according to claim 6, wherein the component (c-1) and the component (c-2) are silver particles.

8. The conductive resin composition according to claim 7, wherein a mass ratio between the component (c-1) and the component (c-2) (component (c-1): component (c-2)) is 20:80 to 70:30.

9. The conductive resin composition according to claim 1, wherein the component (D) is a latent epoxy resin curing agent.

10. The conductive resin composition according to claim 1, wherein the component (D) is a modified aliphatic polyamine-based latent epoxy resin curing agent.

11. The conductive resin composition according to claim 1, wherein a mass loss when an uncured conductive resin composition is heated from 25° C. to 80° C. at a heating rate of 10° C./min and then heated at 80° C. for 1 hour is less than 0.2% by mass.

12. A cured product formed by curing the conductive resin composition according to claim 1.

13. A conductive resin composition comprising the following components (B) to (D):
component (B): a glycidyl amine type epoxy resin having a boiling point of 300° C. or more;
component (C): conductive particles; and
component (D): an epoxy resin curing agent.
